(19) United States
(12) Patent Application Publication
(10) Pub. No.: US 2023/0392655 A1
(43) Pub. Date: Dec. 7, 2023

(54) BRAKE APPARATUS, MOTOR AND ROBOT

(71) Applicant: ABB Schweiz AG, Baden (CH)

(72) Inventors: Jiafan Zhang, Shanghai (CN); Kaiyuan Cao, Shanghai (CN)

(73) Assignee: ABB Schweiz AG, Baden (CH)

(21) Appl. No.: 18/267,284

(22) PCT Filed: Jan. 22, 2021
(86) PCT No.: PCT/CN2021/073281

§ 371 Date: Jun. 14, 2023

(51) Int. Cl. F16D 55/02; H02K 7/102; B25J 19/00

(52) U.S. Cl. CPC F16D 55/02; H02K 7/1023; B25J 19/0004; F16D 2121/22

(57) ABSTRACT

A brake apparatus, a motor, and a robot. The brake apparatus includes a first ring connected to a shaft and being rotatable together with the shaft. Wherein the first ring includes a first set of magnets. The brake apparatus also includes a second ring, which is spaced apart from the first ring by a gap, and includes a second set of magnets, the second set of magnets being magnetically coupled to the first set of magnets such that the second ring tends to rotate along with the first ring. The brake apparatus includes a first member connected to the second ring and being rotatable together with the second ring; and a second member being switchable between a first state and a second state. An impact force will not be transmitted to the shaft when the shaft is rotating, and thus a damping effect can be achieved during braking.

### FIELD

Embodiments of present disclosure generally relate to the field of brake devices, and more particularly, to a brake apparatus, a motor and a robot.

### BACKGROUND

Electro-mechanical brake systems have already been used for some time, for example, to stop a rotation of a motor or a motion of an arm of a robot. In the case of use in a robot, electro-mechanical brake systems can stop the motion of the robot immediately and hold the robot a standstill when the power applied onto the electro-mechanical brake systems is changed.

FIGS. 1-2 schematically illustrate a conventional brake apparatus in different states. As shown in FIGS. 1-2, the conventional brake apparatus comprises a shaft 12A, a hub 20A, a disc 22A, an armature 30A, a spring 42A and a coil 40A. The shaft 12A, the hub 20A and the disc 22A are connected together. When the power is applied to the coil a magnetic attraction force would be generated to attract the armature 30A towards the coil 40A. The magnetic attraction force pulls the armature 30A to compress the spring 42A. Then an air gap is created between the disc 22A and the armature 30A. In this case, the shaft 12A, the hub 20A, and the disc 22A are able to rotate together, as shown in FIG. 1. Once the power of the coil 40A is cut off, the magnetic attraction force would disappear, and the spring 42A will expand to push the armature 30A to press against the disc 22A, as shown in FIG. 2. As such, friction is generated between the armature 30A and the disc 22A, thereby generating a brake torque to block the rotation of the disc 22A. So the rotation of the shaft 12A can be stopped.

However, when the power of the coil 40A is cut off, the disc 22A is actually in a rotation state and the armature 30A suddenly contacts the disc 22A by an elastic force of the spring 42A. An impact force is applied to the disc 22A and the dynamic braking torque acted onto the disc 22A is uncontrollable. In the case of the brake apparatus being used in the robot, this will cause an overload to the robot, which is unexpected.

Accordingly, there is a need for an improved solution for the brake apparatus.

### SUMMARY

In a first aspect of the present disclosure, a brake apparatus is provided. The brake apparatus comprises: a first ring connected to a shaft and being rotatable together with the shaft, the first ring comprising a first set of magnets; a second ring spaced apart from the first ring by a gap and comprising a second set of magnets, the second set of magnets being magnetically coupled to the first set of magnets such that the second ring tends to rotate along with the first ring; a first member connected to the second ring and being rotatable together with the second ring; and a second member being switchable between a first state and a second state, wherein the second member is engaged with the first member to block a rotation of the first member in the first state, and the second member is disengaged from the first member to allow the rotation of the first member in the second state.

With the above embodiments, the second ring can rotate along with the first ring by means of a magnetic coupling force. When a rotation of the shaft needs to be stopped, the second member can be switched into the first state in which it will engage with the first member to block the rotation of the first member, whereby the rotation of the second ring can be blocked. As such, the rotation of the first ring and the shaft can be blocked and then stopped by the magnetic coupling force between the first and second rings.

As there is a gap between the first and second rings, the impact acted on the first member and the second ring will not be transmitted to the first ring and the shaft. Besides, if a braking torque generated between the first and second rings exceeds a maximum magnetic coupling force, a relative sliding would occur between the first and the second rings, thereby a damping effect can be achieved during braking.

In some embodiments, each set of the first and second sets of magnets comprises south-pole magnets and north-pole magnets arranged alternately about a longitudinal axis of the shaft. With these embodiments, the first and second rings can be coupled stably. In this way, the wear of the first member and the second member can be reduced due to the magnetic coupling between the first and second rings.

In some embodiments, the first ring and the second ring are arranged side by side along a longitudinal axis of the shaft. With these embodiments, the brake apparatus can be manufactured easily, and the coupling between the first and second rings is reliable.

In some embodiments, the second ring is arranged around the first ring in a radial direction relative to a longitudinal axis of the shaft. With these embodiments, the brake apparatus would have a more compact size, and the coupling between the first and second rings is reliable.

In some embodiments, each set of the first and second sets of magnets comprises a plurality of magnet arrays arranged coaxially along the longitudinal axis of the shaft, and each of the magnet arrays comprises south-pole magnets and north-pole magnets arranged alternately about the longitudinal axis of the shaft. With these embodiments, the magnetic coupling force between first and second rings can be further increased, and the first and second rings can be coupled stably.

In some embodiments, the first member comprises a disc; and the second member comprises a plate configured to contact the disc in the first state of the second member to block the rotation of the disc by a frictional force applied by the plate. With these embodiments, the structure of the first and second members is simple, and the coupling between the first and second rings is reliable.

In some embodiments, the brake apparatus further comprises: an electromagnet configured to release the plate upon being powered off such that the second member is in the first state and to attract the plate away from the disc upon being powered on such that the second member is in the second state; and a spring arranged between the electromagnet and the plate and configured to push the plate towards the disc when the electromagnet is powered off. With these embodiments, the second member can be switched between the first and second states quickly and reliably.

In some embodiments, the brake apparatus further comprises: an electromagnet configured to release the plate upon being powered off such that the second member is in the second state and to attract the plate to press against the disc upon being powered on such that the second member is in the first state; and a spring arranged between the electromagnet and the plate and configured to push the plate away from the disc when the electromagnet is powered off.

In some embodiments, the first member comprises at least one protrusion extending away from the second ring; and the second member comprises a retractable rod configured to protrude in the first state of the second member to block a rotation of the at least one protrusion and retract in the second state of the second member to allow the rotation of the at least one protrusion. With these embodiments, the switching of the states of the second ring can be achieved in a simple and reliable way.

In some embodiments, the at least one protrusion comprises a plurality of protrusions spaced apart from each other about a longitudinal axis of the shaft so that a space is between the adjacent protrusions; and the retractable rod is adapted to be inserted into the space in the first state of the second member to block the rotation of the plurality of protrusions. With these embodiments, the rotation of the second ring can be stopped quickly and reliably.

In a second aspect of the present disclosure, a motor is provided. The motor comprises: a casing for receiving a rotor and a stator; an output shaft coupled to the rotor; a brake apparatus according to the first aspect of the present disclosure; wherein the output shaft is attached to the shaft of the brake apparatus so that a rotation of the output shaft can be stopped by the brake apparatus. With the above embodiments, the impact acted on the second ring will not be transmitted to the shaft when the shaft is rotating and the second member is switched from the second state to the first state, and thus a damping effect can be achieved.

In a third aspect of the present disclosure, a robot is provided. The robot comprises: a plurality of arms connected via joints; and a motor according to the second aspect of the present disclosure for driving one of the plurality of arms. With the above embodiments, the impact acted on the second ring will not be transmitted to the shaft and the robot during braking and the robot can work in a reliable way.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 schematically illustrates a conventional brake apparatus in a normal state;

FIG. 2 schematically illustrates the conventional brake apparatus of FIG. 1 in a braking state;

FIG. 3 schematically illustrates an example brake apparatus according to some embodiments of the present disclosure;

FIG. 4 schematically illustrates the brake apparatus of FIG. 3 in a braking state;

FIG. 5 illustrates a partial schematic view of the brake apparatus of FIG. 3;

FIG. 6 schematically illustrates a partial side view of the brake apparatus of FIG. 3;

FIG. 7 schematically illustrates another example brake apparatus according to some embodiments of the present disclosure;

FIG. 8 schematically illustrates a partial side view of the brake apparatus of FIG. 7;

FIG. 9 schematically illustrates another example brake apparatus according to some embodiments of the present disclosure;

FIG. 10 schematically illustrates the brake apparatus of FIG. 9 in a braking state; and

FIG. 11 schematically illustrates a side view of a first member of the brake apparatus of FIG. 10.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

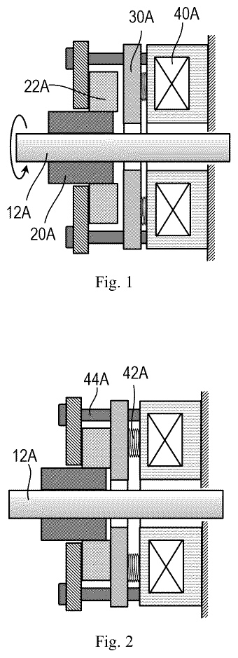

As described above with reference to FIGS. 1 and 2, during the braking, the impact is applied to the disc 22A and the dynamic braking torque acted onto the disc 22A is uncontrollable. Accordingly, there is a need for an improved solution for the brake apparatus.

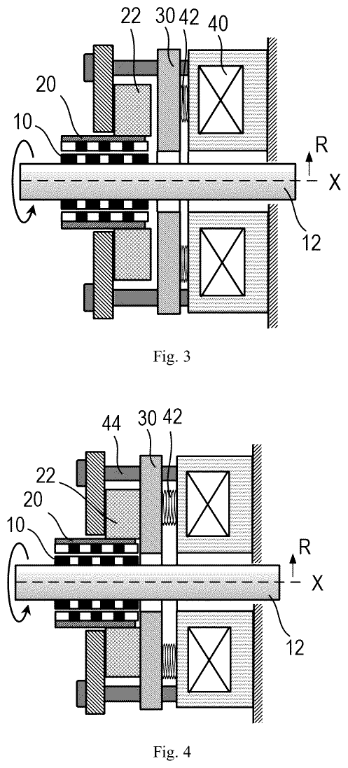

FIG. 3 schematically illustrates an example brake apparatus according to some embodiments of the present disclosure. As shown in FIG. 3, the brake apparatus comprises a first ring 10, a second ring 20, a first member 22 and a second member 30. The first ring 10 is connected to a shaft 12 and is rotatable along with the shaft 12. The first ring 10 comprises a first set of magnets.

The second ring 20 is spaced apart from the first ring 10 by a gap. The second ring 20 comprises a second set of magnets, and the second set of magnets is magnetically coupled to the first set of magnets. Thus, the second ring 20 tends to rotate along with the first ring 10.

Referring to FIG. 3, the first member 22 is connected to the second ring 20 and is rotatable together with the second ring 20. The second member 30 is switchable between a first state and a second state.

In the second state as shown in FIG. 3, the second member 30 is disengaged from the first member 22 to allow a rotation of the first member 22. Thus, the shaft 12 can be rotated without any braking force. As the magnetic coupling force exists between the first and second rings 10, 20, the second ring 20 and the first member 22 may rotate together with the shaft 12.

FIG. 4 schematically illustrates the brake apparatus of FIG. 3 in the first state, i.e., a braking state. As shown in FIG. 4, in the first state, the second member 30 is engaged with the first member 22 to block the rotation of the first member 22. As such, the second ring 20 can block the rotation of the first ring 10 by a magnetic coupling force between the first and second rings 10, 20, whereby a rotation of the shaft 12 can be blocked.

With the above embodiments, when the rotation of the shaft 12 needs to be stopped, the second member 30 can be switched into the first state in which it will engage with the first member 22 to block the rotation of the first member 22, whereby the rotation of the second ring 20 can be blocked. As such, the rotation of the first ring 10 and the shaft 12 can be blocked and then stopped by the magnetic coupling force between the first and second rings 10, 20.

As there is a gap between the first and second rings 10, 20, an impact force acting on the first member 22 and the second ring 20 will not be transmitted to the first ring 10 and the shaft 12. Besides, if a braking torque generated between the first and second rings 10, 20 exceeds a maximum magnetic coupling force created by the first and second sets of magnets, a relative sliding would occur between the first and the second rings 10, 20, thereby a damping effect can be achieved during braking.

In some embodiments, as shown in FIG. 4, the second member 30 contacts the first member 22 to block the rotation of the first member 22 in the first state. A principle of braking will be explained with reference to FIG. 5.

FIG. 5 illustrates a partial schematic view of the brake apparatus of FIG. 3, in which the principle of braking is shown. As shown in FIG. 5, the shaft 12 rotates along a direction Ro around the longitudinal axis X of the shaft 12. The second member 30 will apply a force F onto the first member 22 along a direction parallel to the longitudinal axis X during braking. The force F causes a torque T opposite to the direction Ro. This torque T will stop the rotation of the second ring 20, which will further stop the rotation of the first ring 10 and the shaft 12 by means of the magnetic coupling force between the first and second rings 10, 20.

It is to be understood that the direction of the force F can be of suitable directions other than the examples as described above. The present disclosure does not intend to limit the direction of the force F.

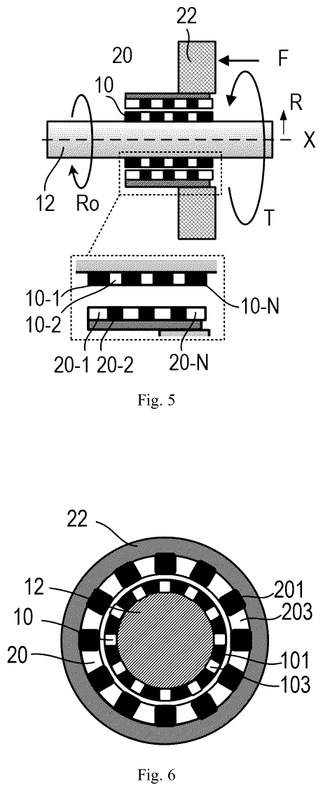

In some embodiments, as shown in FIGS. 3-5, the second ring 20 may be arranged around the first ring 10 in a radial direction R relative to the longitudinal axis X of the shaft 12. In some embodiments, the first ring 10 and the second ring 20 may be arranged concentrically in the radial direction R relative to the longitudinal axis X as shown in FIG. 6 which schematically illustrates a partial side view of the brake apparatus of FIG. 3.

In some embodiments, as shown in FIG. 6, the first ring 10 comprises south-pole magnets 101 and north-pole magnets 103 arranged alternately about the longitudinal axis X of the shaft 12. In some embodiments, the south-pole magnets 101 may be arranged uniformly about the longitudinal axis X of the shaft 12.

It is to be understood that the arrangement of the south-pole magnets 101 and north-pole magnets 103 can be of suitable manners other than the examples as described above. The present disclosure does not intend to limit the arrangement of the south-pole magnets 101 and north-pole magnets 103.

In some embodiments, a spacer may be arranged in each gap of the adjacent north-pole and south-pole magnets 103, 101 to improve a manufacturing process of the first ring 10.

In some embodiments, as shown in FIG. 6, the second set of magnets comprises south-pole magnets 201 and north-pole magnets 203 arranged alternately about the longitudinal axis X of the shaft 12. In some embodiments, the south-pole magnets 201 may be arranged uniformly about the longitudinal axis X of the shaft 12.

It is to be understood that the arrangement of the south-pole magnets 201 and north-pole magnets 203 can be of suitable manners other than the examples as described above. The present disclosure does not intend to limit the arrangement of the south-pole magnets 201 and north-pole magnets 203.

In some embodiments, a spacer may be arranged in each gap of the adjacent north-pole and south-pole magnets 203, 201.

In some embodiments, with reference to FIGS. 3-6, especially FIG. 5 in which an enlarged view of a portion of the brake apparatus is shown, each set of the first and second sets of magnets may comprise a plurality of magnet arrays 10-1, 10-2, . . . , 10-N; 20-1, 20-2, . . . , 20-N arranged coaxially along the longitudinal axis X of the shaft 12. Each array of the magnet arrays 10-1, 10-2, . . . , 10-N; 20-1, 20-2, . . . , 20-N comprises south-pole magnets 101, 201 and north-pole magnets 103, 203 arranged alternately about the longitudinal axis X of the shaft 12 as described above. With these embodiments, the magnetic coupling force between first and second rings 10, 20 can be further increased, and the first and second rings 10, 20 can be coupled stably.

In some embodiments, the first member 22 may comprise a disc and the second member 300 may comprise a plate. Referring back to FIGS. 3-4, the plate is configured to contact the disc in the first state of the second member 30 to block the rotation of the disc by a frictional force applied by the plate.

It is to be understood that the types of the first and second members 22, 30 can be of suitable types other than the examples as described above. The present disclosure does not intend to limit the types of the first and second members 22, 30.

In some embodiments, as shown in FIGS. 3 and 4, the brake apparatus may further comprise an electromagnet 40 and a spring 42. The electromagnet 40 may be configured to release the plate of the second member 30 upon being powered off such that the second member 30 is in the first state as shown in FIG. 4. The electromagnet 40 is also configured to attract the plate away from the disc of the first member 22 upon being powered on such that the second member 30 is in the second state as shown in FIG. 3.

In alternative embodiments, the electromagnet 40 may be configured to release the plate upon being powered off such that the second member 30 is in the second state, and to attract the plate to press against the disc upon being powered on such that the second member 30 is in the first state.

It is to be understood that the switching manner of the electromagnet 40 can be of suitable types other than the examples as described above.

The spring 42 may be arranged between the electromagnet 40 and the plate of the second member 30. When the electromagnet 40 is powered off, the spring 42 expands to push the plate towards the disc of the first member 22 as shown in FIG. 4. In alternative embodiments, when the electromagnet 40 is powered off, the spring 42 expands to push the plate away from the disc.

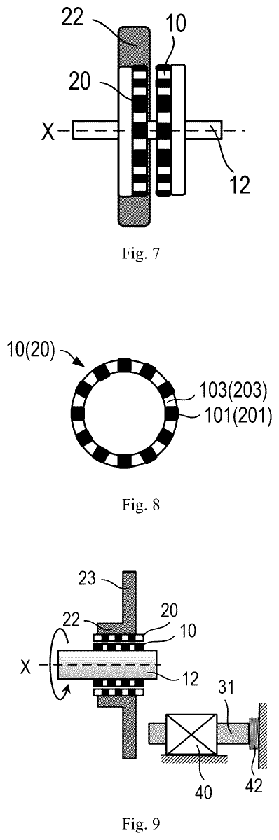

FIG. 7 schematically illustrates another example brake apparatus and FIG. 8 schematically illustrates a partial side view of the brake apparatus of FIG. 7. In some embodiments, as shown in FIGS. 7-8, the first ring 10 and the second ring 20 are arranged side by side along the longitudinal axis X of the shaft 12. When braking, the braking torque, such as the torque T as discussed above, will act on the first member 22 and the second ring 20. Thus, the rotation of the shaft 12 may be stopped by the magnetic coupling force between the first and second rings 10, 20.

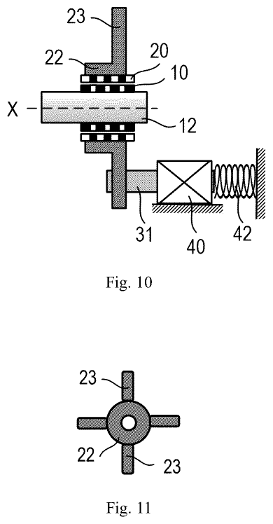

FIGS. 9-10 schematically illustrate another example brake apparatus according to some embodiments of the present disclosure. As shown in FIGS. 9-10, the first member 22 may comprise at least one protrusion 23 and the second member 30 may comprise a retractable rod 31. The at least one protrusion 23 extends away from the second ring 20.

As shown in FIG. 9, in the second state of the second member 30, the retractable rod 31 retracts to allow the rotation of the at least one protrusion 23. As shown in FIG. 10, in the first state of the second member 30 the retractable rod 31 protrudes to block the rotation of the at least one protrusion 23.

FIG. 11 schematically illustrates a side view of a first member of the brake apparatus of FIG. 10. As shown in FIG. 11, the at least one protrusion 23 comprises a plurality of protrusions 23, such as four protrusions, spaced apart from each other about the longitudinal axis X of the shaft 12. With such an arrangement, a space is formed between the adjacent protrusions 23. In the first state of the second member 30, the retractable rod 31 may be inserted into the space to block the rotation of the plurality of protrusions 23 and the first member 22.

In the case that the first and second rings 10, 20 are magnetically coupled to each other, a dynamic braking torque acting on the second ring 20 and the first member 22 is controllable.

According to embodiments of the present disclosure, a motor is provided. The motor comprise a casing, an output shaft, and a brake apparatus as discussed above. The casing is used for receiving a rotor and a stator, and the output shaft is coupled to the rotor. The output shaft is attached to the shaft 12 of the brake apparatus so that a rotation of the output shaft can be stopped by the brake apparatus. By means of the brake apparatus as discussed above, an impact generated during the braking may be prevented from being transmitted to the motor.

According to embodiments of the present disclosure, a robot is provided. The robot comprises a plurality of arms connected via joints; and a motor as discussed above. The motor is used to drive one of the plurality of arms. By the motor as discussed above, the robot may work reliably and the impact generated during the braking will not be transmitted to the robot.

As discussed above, the dynamic braking torque acted on the second ring 20 and the first member 22 can be controllable, and thus the dynamic braking torque can be controlled to not reach a maximum allowable dynamic braking torque required for safety operation of the robot.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be included in the scope of protection of the present disclosure. Meanwhile, appended claims of the present disclosure aim to cover all the variations and modifications falling under the scope and boundary of the claims or equivalents of the scope and boundary.

1. A brake apparatus comprising:
a first ring connected to a shaft and being rotatable together with the shaft, the first ring comprising a first set of magnets;
a second ring spaced apart from the first ring by a gap and comprising a second set of magnets, the second set of magnets being magnetically coupled to the first set of magnets such that the second ring tends to rotate along with the first ring;
a first member connected to the second ring and being rotatable together with the second ring; and
a second member being switchable between a first state and a second state, wherein the second member is engaged with the first member to block a rotation of the first member in the first state, and the second member is disengaged from the first member to allow the rotation of the first member in the second state.

2. The brake apparatus of claim 1, wherein each set of the first and second sets of magnets comprises south-pole magnets and north-pole magnets arranged alternately about a longitudinal axis of the shaft.

3. The brake apparatus of claim 1, wherein the first ring and the second ring are arranged side by side along a longitudinal axis of the shaft.

4. The brake apparatus of claim 1, wherein the second ring is arranged around the first ring in a radial direction (R) relative to a longitudinal axis of the shaft.

5. The brake apparatus of claim 4, wherein each set of the first and second sets of magnets comprises a plurality of magnet arrays arranged coaxially along the longitudinal axis of the shaft, and each of the magnet arrays comprises south-pole magnets and north-pole magnets arranged alternately about the longitudinal axis of the shaft.

6. The brake apparatus of claim 1, wherein,
the first member comprises a disc; and
the second member comprises a plate configured to contact the disc in the first state of the second member to block the rotation of the disc by a frictional force applied by the plate.

7. The brake apparatus of claim 6, further comprising:
an electromagnet configured to release the plate upon being powered off such that the second member is in the first state and to attract the plate away from the disc upon being powered on such that the second member is in the second state; and
a spring arranged between the electromagnet and the plate and configured to push the plate towards the disc when the electromagnet is powered off.

8. The brake apparatus of claim 6, further comprising:
an electromagnet configured to release the plate upon being powered off such that the second member is in the second state and to attract the plate to press against the disc upon being powered on such that the second member is in the first state; and
a spring arranged between the electromagnet and the plate and configured to push the plate away from the disc when the electromagnet is powered off.

9. The brake apparatus of claim 1, wherein,
the first member comprises at least one protrusion extending away from the second ring; and
the second member comprises a retractable rod configured to protrude in the first state of the second member to block a rotation of the at least one protrusion and retract in the second state of the second member to allow the rotation of the at least one protrusion.

10. The brake apparatus of claim 9, wherein,
the at least one protrusion comprises a plurality of protrusions spaced apart from each other about a longitudinal axis of the shaft so that a space is between the adjacent protrusions; and
the retractable rod is adapted to be inserted into the space in the first state of the second member to block the rotation of the plurality of protrusions.

11. A motor comprising,
a casing for receiving a rotor and a stator;
an output shaft coupled to the rotor;
a brake apparatus according to claim 1;
wherein the output shaft is attached to the shaft of the brake apparatus so that a rotation of the output shaft can be stopped by the brake apparatus.

12. A robot comprising:
a plurality of arms connected via joints; and
a motor according to claim 11 for driving one of the plurality of arms.
